(19) United States
(12) Patent Application Publication
(10) Pub. No.: US 2009/0063281 A1
(43) Pub. Date: Mar. 5, 2009

(54) In-call enterprise advertisement

(76) Inventors: Randolph M. Haldeman, Menlo Park, CA (US); Donald R. Steul, San Francisco, CA (US)

Correspondence Address: STEVENS LAW GROUP, 1754 TECHNOLOGY DRIVE, SUITE 226, SAN JOSE, CA, 95110, US

(21) Appl. No.: 12/214,540

(22) Filed: Jun. 19, 2008

Related U.S. Application Data
(63) Continuation-in-part of application No. 12/001,068, filed on Dec. 7, 2007.
Application No. 12/001,068 is a continuation-in-part of application No. 11/635,375, filed on Dec. 6, 2006.
(60) Provisional application No. 60/873,655, filed on Dec. 8, 2006.
(60) Provisional application No. 60/936,299, filed on Jun. 18, 2007.

(51) Int. Cl. G06Q 30/00; G06Q 40/00; G06Q 10/00; G06Q 90/00

(52) U.S. Cl. 705/14; 705/37; 705/1

(57) ABSTRACT

A call is received by an entity from a caller. The entity plays an initial greeting to the caller and provides a list of options to the caller. The entity receives a caller selection from the list of options and offers the caller an opportunity to opt-out of listening to advertisements while waiting for a representative. If the caller does not opt-out of listening to advertisements, an advertisement is selected for the caller from among multiple advertisements. The advertisement is selected based on the caller's selection, bid prices associated with the multiple advertisements, and information known about the caller from previous calls.

### RELATED APPLICATIONS

This application is a Continuation in Part of U.S. patent application Ser. No. 12/001,068, filed Dec. 7, 2007, the disclosure of which is incorporated by reference herein. That application is a Continuation in Part of U.S. patent application Ser. No. 11/635,375, filed Dec. 6, 2006, the disclosure of which is incorporated by reference therein. That application also claims the benefit of U.S. Provisional Application No. 60/873,655, filed Dec. 8, 2006, the disclosure of which is incorporated by reference therein.

This application also claims the benefit of U.S. Provisional Application No. 60/936,299, filed Jun. 19, 2007, the disclosure of which is incorporated by reference herein.

### TECHNICAL FIELD

The present invention relates to providing one or more advertisements to a user, such as a caller using a voice-based communication device.

### BACKGROUND

Businesses and other organizations that receive phone calls often need to put incoming calls on hold for a period of time until an employee (or business associate) can answer the incoming call. Typically, callers hear music or silence while they are on hold. When an employee becomes available to answer the incoming call, the music (or silence) ends and the caller communicates with the employee handling the call.

Instead of playing music for callers on hold, some existing systems provide general information about the business or organization. This general information may include store location, hours of operation, products or services offered, or other information that might be of interest to the caller. However, these systems provide the same general information to all callers regardless of whether a particular caller has requested such information.

### BRIEF DESCRIPTION OF THE DRAWINGS

Similar reference numbers are used throughout the figures to reference like components and/or features.

FIG. 1 is a block diagram illustrating an example environment for handling incoming calls and providing advertisements to callers while they are on hold waiting for assistance from a business employee or associate.

FIG. 2 is a block diagram illustrating various components of an example advertisement management module.

FIG. 3 is a flow diagram illustrating an embodiment of a procedure for processing an incoming call.

FIG. 4 is a flow diagram illustrating an embodiment of a procedure for selecting advertisements to play to a caller.

FIG. 5 is a block diagram illustrating an example computing device.

### DETAILED DESCRIPTION

The systems and methods described herein provide a mechanism for communicating one or more advertisements to callers while they are on hold waiting for assistance from a business employee, associate, or other representative. The advertisements may be general advertisements that advertise the business itself or that advertise specific products or services. In certain situations, the advertisements played to the caller are targeted advertisements. A targeted advertisement is communicated to a particular caller based on information known about that caller. For example, if a caller is an electrician calling a hardware store, targeted advertisements may include advertisements for electrical switches, wire, electrical tools, and the like.

Targeted advertisements are beneficial to the business because they generally receive a better response rate than non-targeted advertisements. For example, sending advertisements for painting supplies to an electrician is not likely to generate a positive response. Such advertisements may be annoying to callers that have no interest in the content of the advertisement. Targeted advertisements are less likely to be an annoyance to callers because there is a strong likelihood that the caller has an interest in the content of the advertisement. Thus, increased knowledge about the caller can benefit the business with an improved response rate and benefit the caller by reducing the number of non-interesting advertisements received.

In particular examples discussed herein a “user” may also be referred to as a “caller”. The systems and methods described herein receive calls from various callers. The caller may invoke a call via a conventional telephone system, using voice over internet protocol (VoIP), cellular phone, or any other communication device or system. Although certain examples discuss calls to a business or organization, similar procedures and systems can be used with calls to any entity for any reason.

Specific examples discussed herein relate to voice advertising (e.g., playing voice or other audio-based messages to callers). However, the systems and methods discussed herein can be used with any type of advertising and with any type of advertisement system. Alternate types of messages include text messages, email messages, instant messages, and the like. The described systems and methods may be implemented as a stand-alone system or may be incorporated into one or more other systems.

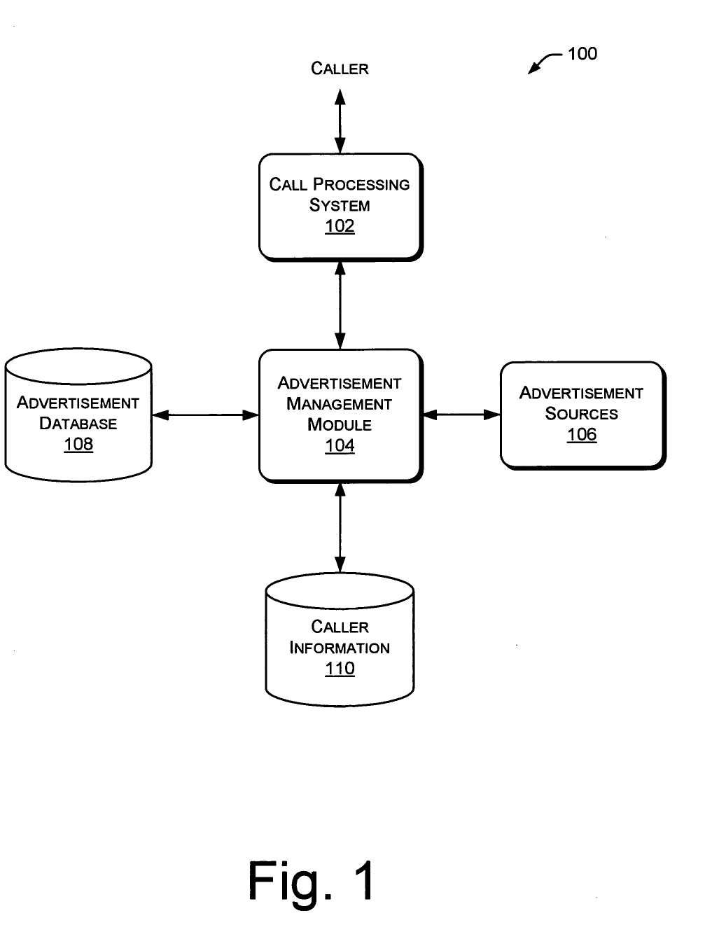

FIG. 1 is a block diagram illustrating an example environment 100 for handling incoming calls and providing advertisements to callers while they are on hold waiting for assistance from a business employee or associate. A call processing system 102 receives incoming calls from any number of callers and handles the processing of the incoming calls. This processing includes playing a welcome greeting, playing a list of options for the caller, placing the caller on hold if an employee is not readily available to answer the call, and requesting one or more advertisements from an advertisement management module 104. When requesting advertisements from advertisement management module 104, call processing system 102 provides information known about the caller to the advertisement management module. This caller information includes, for example, the caller's name and/or phone number, and the option selected by the caller (selected from the list of options provided by call processing system 102).

Advertisement management module 104 is coupled to one or more advertisement sources 106, an advertisement database 108, and a caller information database 110. Advertisement management module 104 selects one or more advertisements for playback by call processing system 102 based on caller information, available advertisements, bid values for available advertisements, and the like. Example advertisement sources 106 include product suppliers, service suppliers, advertising agencies, and so forth. Advertisement database 108 stores advertisements received from advertisement sources 106 along with additional information associated with the advertisements, such as the associated supplier, bid value, and a category (e.g., paint, electrical, or plumbing) associated with the advertisement. Caller information 110 includes other known information about the caller, such as previous buying habits, caller occupation, demographic information related to the caller, and the like. Advertisement management module 104 uses the known caller information and information associated with the advertisements to select one or more advertisements that are likely to be of interest to the caller.

Information about the caller may be known from various sources, such as information obtained based on the caller's phone number and information provided by the caller regarding the reason for their call. For example, when an incoming call is answered, the caller may be provided with a list of options (e.g., “Press 1 for store hours, Press 2 for the paint department, Press 3 for the electrical department . . . ”). If the caller presses “2”, then the system knows the caller is calling about a paint-related product or has a paint-related inquiry.

The systems and methods described herein use the caller information to target advertisements played to the caller while they are on hold. For example, if the caller has requested the paint department, then the caller receives advertisements related to paint, such as particular brands of paint carried by the business, discounts on Oscar brand paint brushes, Acme brand ladders, and special types of painters tape from Tape Inc. In a particular embodiment, the business receiving the call provides advertisements for other companies (e.g., the suppliers of products sold by the business). In the paint example discussed above, the suppliers include manufacturers of paint, brushes, ladders, tape, and other painting supplies. These suppliers may provide the actual advertisements for the business to play to the callers or they may provide the written content for the advertisement, but the business records the actual audio advertisement. Alternatively, the business may create the advertisement on behalf of the supplier.

Although two separate databases 108 and 110 are shown in FIG. 1, alternate embodiments may include any number of databases coupled to advertisement management module 104. Further, alternate embodiments may combine database information into more or less than three databases. For example, the data contained in advertisement database 108 may be merged with caller information 110 in a single database. Similarly, the data contained in advertisement database 108 or caller information 110 may be distributed across multiple databases.

An advertiser may be the business or organization receiving the call or another entity. For example, a grocery store may receive a call and play advertisements related to their own business, such as a sale in the deli department or a discount coupon for any purchase of fresh produce. Alternatively, the grocery store may play advertisements to callers for a specific product, such as a specific brand of cereal. In this example, the grocery store may charge a fee to the manufacturer of that brand of cereal as a result of playing the advertisement to callers. In another embodiment, the grocery store may play advertisements to callers for other businesses, such as a dry cleaning store or a book store located in the same shopping center as the grocery store.

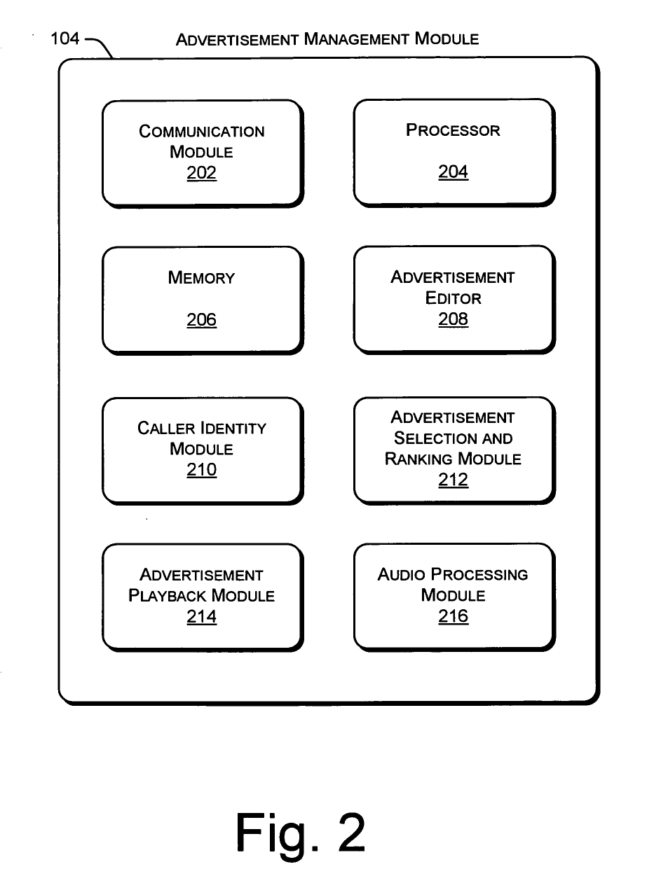

FIG. 2 is a block diagram illustrating various components of example advertisement management module 104. Advertisement management module 104 includes a communication module 202, a processor 204, and a memory 206. Communication module 202 allows advertisement management module 104 to communicate with other devices and services, such as databases, networks, other computer systems, advertisement-related services, and so on. Processor 204 executes various instructions to implement the functionality provided by advertisement management module 104. Memory 206 stores these instructions as well as other data used by processor 204 and other modules contained in advertisement management module 104.

Advertisement management module 104 also includes an advertisement editor 208, which allows users (e.g., advertisers, CMRs, and ad agencies) to create and edit advertisements. Advertisement editor 208 also allows users to define various parameters associated with each advertisement, such as the business category, time-of-day to run the advertisement, day-of-week, maximum bid price, how frequently the advertisement can be played, and the like.

Advertisement management module 104 further includes a caller identity module 210, which determines the identity of a caller. For example, caller identity module 210 may receive a phone number associated with an incoming call. Caller identity module 210 accesses a caller database or other data source to determine the identity of the caller. Once the caller is identified, additional information about the caller can be retrieved from caller information 110 or another internal or external data source, such as a store's buyer's club card database. This additional information includes, for example, information requested during previous calls, previous advertisements played to the caller, demographics of the caller, environmental factors, past purchasing habits, and the like. Example environmental factors include the current temperature in a geographic area and whether snow is forecast for the area. Such additional information is useful in targeting advertisements of interest to the caller.

Advertisement management module 104 also includes an advertisement selection and ranking module 212. This module selects one or more advertisements to be played to a caller based on various factors, which are discussed in greater detail herein. Advertisement selection and ranking module 212 also ranks multiple advertisements based on one or more criteria. This ranking determines the order in which the multiple advertisements are presented (e.g., played) to the caller. An advertisement playback module 214 plays advertisements in the form of audio files, text-to-speech data, or other data to one or more callers. Advertisement playback module 214 performs the necessary data processing to convert the advertisement data into audible sounds that are communicated to the caller.

An audio processing module 216 performs various filtering and other modifications to audio recordings to improve the sound quality of the audio recordings and to maintain consistent volume levels, consistent audio quality, and the like between multiple audio recordings. For example, audio processing module 216 may reduce background noise, reduce “clicks and pops” in the recording, modulate the frequencies in the recording, and generally smooth the audio sounds. These audio processing steps are particularly useful, for example, with audio recordings created by a user calling on a poor quality telephone connection.

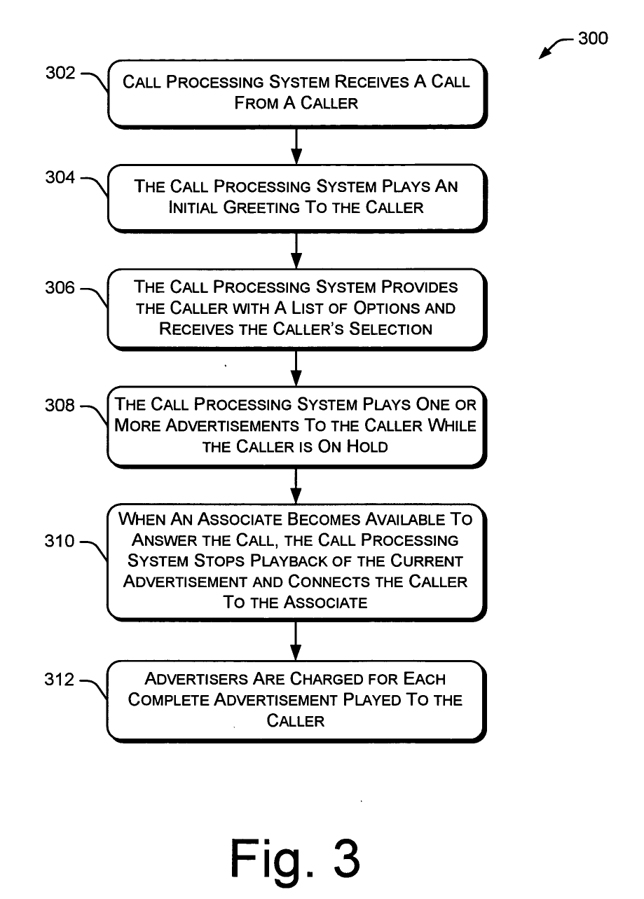

FIG. 3 is a flow diagram illustrating an embodiment of a procedure 300 for processing an incoming call. In one embodiment, procedure 300 is implemented in the environment shown in FIG. 1. In other embodiments, procedure 300 is implemented using one or more computing devices or other systems capable of performing the operations shown in FIG. 3.

Initially, a call processing system (e.g., call processing system 102 shown in FIG. 1) receives a call from a caller (block 302). The call processing system plays an initial greeting to the caller (block 304). The initial greeting typically thanks the caller for contacting the business and may provide the name of the business, such as “Thank you for calling Robert's Hardware Center.” Procedure 300 continues by providing the caller with a list of options and receives the caller's selection (block 306). The list of options may identify different departments within the business (e.g., electrical, plumbing, painting, etc.), information the caller may need about the business (e.g., store hours, store location, etc.), and the like. An example list of options provided to a caller includes “Please press 1 for store hours, press 2 for the paint department, press 3 for the electrical department, press 4 for the plumbing department, press 5 for customer service.” The announcement of the various options stops as soon as the caller selects one of the options. For example, if the caller presses “2” after hearing that option, the call processing system does not continue announcing the remaining options (i.e., the options associated with pressing “3”, “4”, and “5”).

After the caller selects a particular option, the call processing system plays a message to the caller, such as:
While you're waiting for an associate to answer your call, you can hear special promotions from our paint department suppliers. You won't lose your place in line. At any time, you can press 1 to continue listening to music. Just stay on the line to hear the special promotions.
   Next, the call processing system plays one or more advertisements to the caller while the caller is on hold (block 308). As discussed above, the call processing system may request these advertisements from an advertisement management module, such as advertisement management module 104 shown in FIG. 1. The advertisements played to the caller are targeted to the caller based on the option selected by the caller in block 306 and, optionally, other information known about the caller and other business rules. Information about the caller includes name, prior purchases, demographic information, and the like. Business rules include time of day to run particular advertisements, days of the week to run particular advertisements, and throttling rules. This information about the caller and the business rules as discussed further herein.

For example, if the caller selected the option associated with the paint department, they may hear the following advertisements:
This week at Robert's Hardware Center, buy one gallon of Olympic interior paint and get a second gallon of paint at half price. Olympic paint is the choice of professional painters.
The Warner eight foot fiberglass step ladder is sturdy and safe for all painting needs. The ladder has a convenient tray for paint cans and slip-resistant steps.
Scotch brand painters tape will make your job easier, try some . . . . Hello, this is Maria in the paint department, how can I help you?
   In the above example, the caller hears two complete advertisements (Olympic paint and Warner ladder) and one partial advertisement (Scotch brand tape). In this situation, advertisement sources associated with the two complete advertisements are charged a fee for playing a complete advertisement. The advertisement source associated with the partial advertisement is not charged for playing the incomplete advertisement. These charges are tracked by advertisement management module 104 and stored in advertisement database 108. Advertisement sources are billed for their played advertisements at periodic intervals, such as weekly or monthly. The three advertisements played in the example above represent the three paint-related advertisements having the highest associated bid price and/or the highest relevance to the caller (based on information known about the caller). In this example, the Olympic paint advertisement had the highest bid price (or relevance), the Warner ladder advertisement had the next highest bid price (or relevance), and the Scotch tape advertisement had the third highest bid price (or relevance).

As shown in the above example, when an associate becomes available to answer the call that's been placed on hold, the call processing system stops playback of the current advertisement and connects the caller to the associate (block 310). Finally, advertisers are charged for each complete advertisement played to the caller (block 312).

In a particular embodiment, advertisers (e.g., suppliers) can bid for the position or ranking of their advertisement. For example, an advertiser may bid a higher price if their advertisement is played first to the caller. Additional embodiments use extra data known about the caller to select an advertisement or promotion. For example, if a grocery store's database shows that the caller never buys napkins at that store, then the caller probably buys napkins at another store. Thus, the store may offer a special coupon or other promotion to the caller as an incentive for the caller to buy napkins at that store instead. Coupons may be sent to callers via email, fax, text messaging to cellular phones or other portable devices, and the like.

Advertisers may establish a deposit account, from which advertisement playback fees are deducted. Such a deposit account may be used instead of sending out, for example, monthly invoices.

As mentioned above, advertisement database 108 (FIG. 1) contains advertisements received from various advertisement sources along with additional information associated with the advertisements, such as the associated supplier, maximum bid value, maximum advertisement frequency (also referred to as “throttle”), and a category (e.g., paint, electrical, or plumbing) associated with the advertisement. Advertisements have an associated maximum price (i.e., “bid price”), which represents the maximum amount the advertiser is willing to pay each time the advertisement is played to a caller. Since the advertiser knows that their advertisement is being targeted to specific callers that are likely to be interested in the advertiser's products or services, the advertiser is likely to bid a higher price for the advertisement than for a similar non-targeted advertisement.

Advertisers may also specify a maximum number of times a particular advertisement can be played during a specific time period—also referred to as “throttling”. For example, an advertiser may specify that a particular advertisement is played a maximum of five times per hour or a maximum of 20 times per day. Additionally, advertisers may define throttling parameters during certain time periods and not define any throttling during other time periods. Throttling advertisements during specific time periods helps the advertiser control the flow of calls or orders during those time periods. In a particular example, a deli department that sells sandwiches may limit the number of advertisements played from 11 am-1 pm on Monday-Friday (the typical lunch period) to avoid receiving more orders than they can effectively handle during that period. At other times of the day (and on Saturday and Sunday), when sandwich orders are less frequent, the deli department does not need to throttle their advertisements.

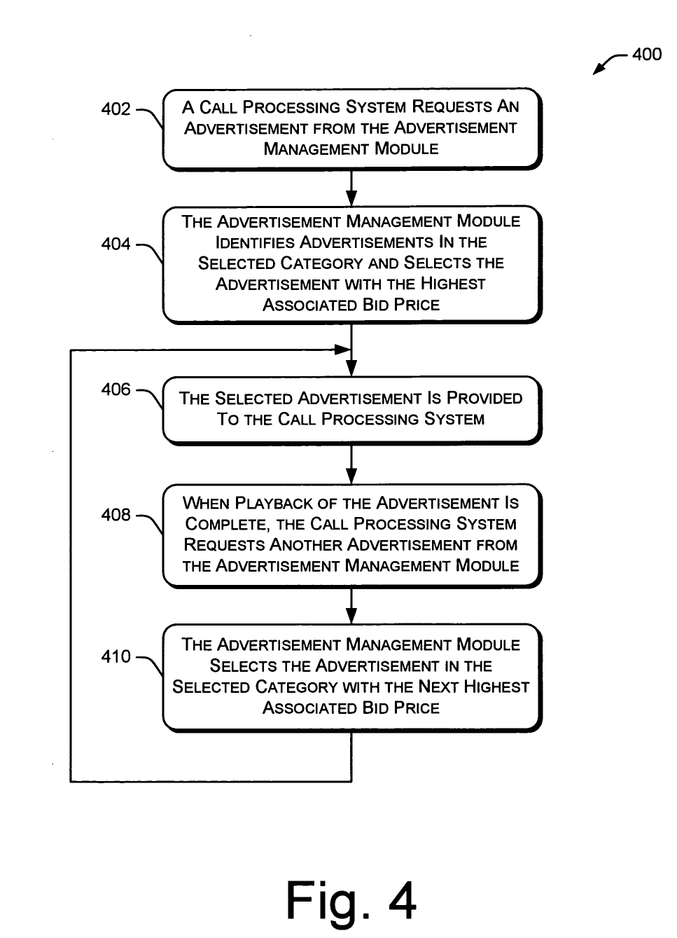

FIG. 4 is a flow diagram illustrating an embodiment of a procedure 400 for selecting advertisements to play to a caller. In the example of FIG. 4, advertisements are selected based on a category and a bid price associated with each advertisement. In one embodiment, procedure 400 is implemented in the environment shown in FIG. 1. In other embodiments, procedure 400 is implemented using one or more computing devices or other systems capable of performing the operations shown in FIG. 4.

Initially, the call processing system requests an advertisement from the advertisement management module (block 402). The advertisement management module identifies advertisements in the selected category (e.g., paint department) and selects the advertisement with the highest associated bid price and/or relevance to the caller (block 404). The selected advertisement is provided by the advertisement management module to the call processing system (block 406). The call processing system plays the received advertisement to the caller. When playback of the advertisement is complete, the call processing system requests another advertisement from the advertisement management module (block 408). The advertisement management module then selects the advertisement in the selected category with the next highest associated bid price and/or the next highest relevance to the caller (block 410). The selected advertisement is provided to the call processing system (block 406). This process continues until an associate becomes available to answer the call.

In a specific implementation, the caller is given an option to listen to music or have silence on the telephone line while on hold. For example, the caller may be provided with the instruction “If you do not want to hear the supplier offers, press the pound key on your phone to listen to music or press the star key to have silence on the telephone line.” In this implementation, the system defaults to providing the caller with one or more supplier advertisements. Thus, the caller may specifically opt-out of receiving the supplier advertisements. Additionally, the caller is notified that they will not lose their place in the queue of callers on hold if they listen to the supplier advertisements. As discussed here, the caller is connected with a representative when a representative is available, regardless of whether the caller has listened to a portion of an advertisement. By operating in this manner, callers may be more likely to listen to the advertisements knowing that their call will be answered at the same time whether they choose to hear advertisements, music, or silence.

The advertising management module discussed herein also collects information regarding advertisement statistics for reporting to advertisers. For example, the advertising management system collects and stores information regarding the number of times an advertisement is played to a caller, the number of times an advertisement is selected by a caller (e.g., the caller requests more information or requests a coupon), the cost of each advertisement playback, and so forth. This information is reported to advertisers to allow the advertisers to evaluate the results of their advertising campaigns.

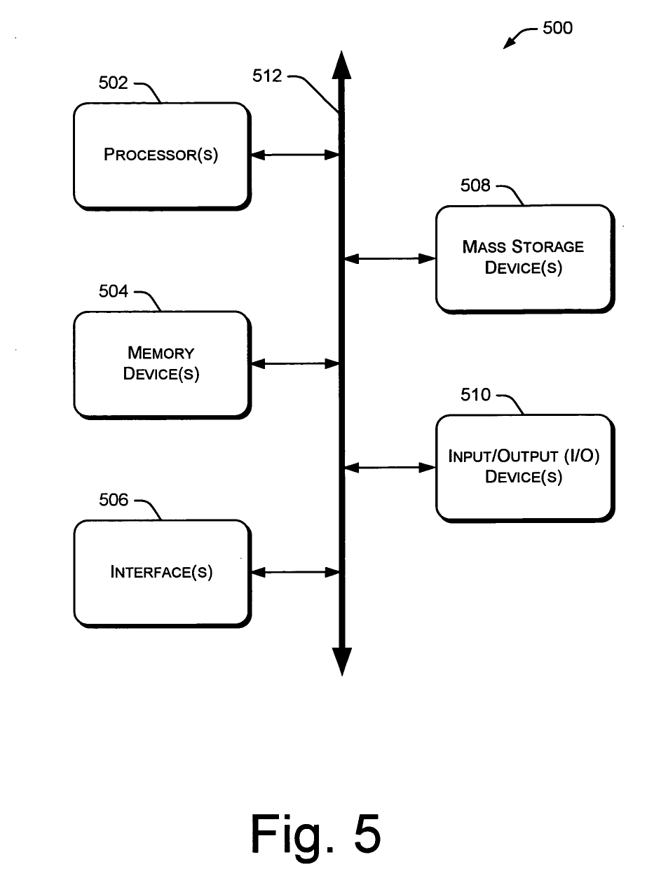

FIG. 5 is a block diagram illustrating an example computing device 500. Computing device 500 may be used to perform various procedures, such as those discussed herein. Computing device 500 can function as a server, a client, or any other computing entity. Computing device 500 can be any of a wide variety of computing devices, such as a desktop computer, a notebook computer, a server computer, a handheld computer, and the like.

Computing device 500 includes one or more processor(s) 502, one or more memory device(s) 504, one or more interface(s) 506, one or more mass storage device(s) 508, and one or more Input/Output (I/O) device(s) 510, all of which are coupled to a bus 512. Processor(s) 502 include one or more processors or controllers that execute instructions stored in memory device(s) 504 and/or mass storage device(s) 508. Processor(s) 502 may also include various types of computer-readable media, such as cache memory.

Memory device(s) 504 include various computer-readable media, such as volatile memory (e.g., random access memory (RAM)) and/or nonvolatile memory (e.g., read-only memory (ROM)). Memory device(s) 504 may also include rewritable ROM, such as Flash memory.

Mass storage device(s) 508 include various computer readable media, such as magnetic tapes, magnetic disks, optical disks, solid state memory (e.g., Flash memory), and so forth. Various drives may also be included in mass storage device(s) 508 to enable reading from and/or writing to the various computer readable media. Mass storage device(s) 508 include removable media and/or non-removable media.

I/O device(s) 510 include various devices that allow data and/or other information to be input to or retrieved from computing device 500. Example I/O device(s) 510 include cursor control devices, keyboards, keypads, microphones, monitors or other display devices, speakers, printers, network interface cards, modems, lenses, CCDs or other image capture devices, and the like.

Interface(s) 506 include various interfaces that allow computing device 500 to interact with other systems, devices, or computing environments. Example interface(s) 506 include any number of different network interfaces, such as interfaces to local area networks (LANs), wide area networks (WANs), wireless networks, and the Internet.

Bus 512 allows processor(s) 502, memory device(s) 504, interface(s) 506, mass storage device(s) 508, and I/O device(s) 510 to communicate with one another, as well as other devices or components coupled to bus 512. Bus 512 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 500, and are executed by processor(s) 502. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
receiving a call from a caller, wherein the call is received by an entity;
playing an initial greeting to the caller;
providing a list of options to the caller;
receiving a caller selection from the list of options;
offering the caller an opportunity to opt-out of listening to advertisements while waiting for a representative;
if the caller does not opt-out of listening to advertisements:
selecting a first advertisement for the caller from among a plurality of advertisements, wherein the first advertisement is selected based on the caller selection, bid prices associated with the plurality of advertisements, and information known about the caller from previous calls; and
playing the first advertisement to the caller.

2. A method as recited in claim 1 further comprising notifying the caller that they will not lose their place in a caller queue if they listen to advertisements.

3. A method as recited in claim 1 wherein playing of the first advertisement is terminated when the call is answered by a representative of the entity.

4. A method as recited in claim 1 further comprising charging an advertiser associated with the first advertisement upon completion of playing of the first advertisement to the caller.

5. A method as recited in claim 1 further comprising:
upon completion of playing the first advertisement to the caller, selecting a second advertisement for the caller from among the plurality of advertisements, wherein the second advertisement is selected based on the caller selection, bid prices associated with the plurality of advertisements, and information known about the caller from previous calls; and
playing the second advertisement to the caller.

6. A method as recited in claim 1 wherein selecting a first advertisement for the caller from among a plurality of advertisements further includes evaluating throttling parameters associated with the plurality of advertisements.

7. A method as recited in claim 1 wherein selecting a first advertisement for the caller from among a plurality of advertisements further includes evaluating at least one business rule associated with the plurality of advertisements.

8. A method as recited in claim 1 wherein the information known about the caller from previous calls includes demographic information associated with the caller.

9. A method as recited in claim 1 wherein the information known about the caller from previous calls includes the caller's previous purchases from the entity.

10. A method as recited in claim 1 wherein the advertisement is an audio-based advertisement.

11. A method comprising:
receiving a call from a caller, wherein the call is received by an entity;
if a representative of the entity is not available to handle the call:
providing a list of options to the caller;
receiving a caller selection from the list of options;
offering the caller an opportunity to opt-out of listening to advertisements while waiting for a representative;
notifying the caller that they will not lose their place in a caller queue if they listen to advertisements;
if the caller does not opt-out of listening to advertisements:
selecting a first advertisement for the caller from among a plurality of advertisements, wherein the first advertisement is selected based on the caller selection, bid prices associated with the plurality of advertisements, and at least one business rule associated with the plurality of advertisements; and
playing the first advertisement to the caller.

12. A method as recited in claim 11 further comprising charging an advertiser associated with the first advertisement upon completion of playing the first advertisement to the caller.

13. A method as recited in claim 11 further comprising terminating playback of the first advertisement when a representative of the entity becomes available to handle the call.

14. A method as recited in claim 11 wherein selecting a first advertisement for the caller from among a plurality of advertisements further includes evaluating purchasing habits of the caller.

15. A method as recited in claim 11 wherein the list of options includes a plurality of departments within the entity.

16. A method as recited in claim 11 wherein the list of options includes a plurality of categories of products or services offered by the entity.

17. An apparatus comprising:
a call processing system to receive calls from callers and to play audio messages to the callers; and
an advertisement management module coupled to the call processing system, the advertisement management module to select a first advertisement for a particular caller from among a plurality of advertisements based on bid prices associated with the plurality of advertisements and information known about the particular caller from previous interaction with the particular caller, the advertisement management module further to provide the first advertisement to the call processing system for playing to the particular caller.

18. An apparatus as recited in claim 17 wherein the advertisement management module is coupled to receive a plurality of advertisements from a plurality of advertisement sources.

19. An apparatus as recited in claim 17 further comprising an advertisement database coupled to the advertisement management module, the advertisement database to store the plurality of advertisements.

20. An apparatus as recited in claim 17 further comprising a caller information database coupled to the advertisement management module, the caller information database to store information associated with a plurality of callers.
